(19) United States
(12) Patent Application Publication
(10) Pub. No.: US 2011/0282866 A1
(43) Pub. Date: Nov. 17, 2011

(54) System And Method For Retrieving And Processing Information From A Supervisory Control Manufacturing/Production Database

(75) Inventors: Brian Erickson, Long Beach, CA (US); Abhijit Manushree, Aliso Viejo, CA (US); Vinay Kamath, Rancho Santa Margarita, CA (US); Elliott Middleton, Tyler, TX (US)

(73) Assignee: Invensys Systems, Inc., Foxboro, MA (US)

(21) Appl. No.: 12/781,662

(22) Filed: May 17, 2010

(51) Int. Cl. G06F 17/30

(52) U.S. Cl. 707/722; 707/E17.044

(57) ABSTRACT

A database server for handling steams of time stamped data points for tagged variables is disclosed herein that supports a set of advanced data retrieval operations/queries invoked by clients of the database server. The advanced data retrieval operations are invoked by client queries to provide, on demand, secondary information by processing previously tabled data corresponding to received data streams rendered by a variety of data sources in a supervisory control/monitoring, process control and/or automated equipment environment. Calculations, on previously stored data, for rendering the secondary information are performed within the database server at the time the secondary information is requested by a client of the historian that maintains a database containing the previously stored data. Moreover, a filtering stage and enhanced time-in-state processing operations are supported.

### TECHNICAL FIELD

The present invention generally relates to computing and networked data storage systems, and, more particularly, to techniques for managing (e.g., storing, retrieving, processing, etc.) streams of supervisory control, manufacturing, and production information. Such information is typically rendered and stored in the context of supervising automated processes and/or equipment. The data is thereafter accessed by a variety of database clients such as, for example, by trending applications.

### BACKGROUND

Industry increasingly depends upon highly automated data acquisition and control systems to ensure that industrial processes are run efficiently and reliably while lowering their overall production costs. Data acquisition begins when a number of sensors measure aspects of an industrial process and report their measurements back to a data collection and control system. Such measurements come in a wide variety of forms. By way of example the measurements produced by a sensor/recorder include: a temperature, a pressure, a pH, a mass/volume flow of material, a counter of items passing through a particular machine/process, a tallied inventory of packages waiting in a shipping line, cycle completions, etc. Often sophisticated process management and control software examines the incoming data associated with an industrial process, produces status reports and operation summaries, and, in many cases, responds to events/operator instructions by sending commands to actuators/controllers that modify operation of at least a portion of the industrial process. The data produced by the sensors also allow an operator to perform a number of supervisory tasks including: tailor the process (e.g., specify new set points) in response to varying external conditions (including costs of raw materials), detect an inefficient/non-optimal operating condition and/or impending equipment failure, and take remedial action such as move equipment into and out of service as required.

A very simple and familiar example of a data acquisition and control system is a thermostat-controlled home heating/air conditioning system. A thermometer measures a current temperature, the measurement is compared with a desired temperature range, and, if necessary, commands are sent to a furnace or cooling unit to achieve a desired temperature. Furthermore, a user can program/manually set the controller to have particular setpoint temperatures at certain time intervals of the day.

Typical industrial processes are substantially more complex than the above-described simple thermostat example. In fact, it is not unheard of to have thousands or even tens of thousands of sensors and control elements (e.g., valve actuators) monitoring/controlling all aspects of a multi-stage process within an industrial plant or monitoring units of output produced by a manufacturing operation. The amount of data sent for each measurement and the frequency of the measurements varies from sensor to sensor in a system. For accuracy and to facilitate quick notice/response of plant events/upset conditions, some of these sensors update/transmit their measurements several times every second. When multiplied by thousands of sensors/control elements, the volume of data generated by a plant's supervisory process control and plant information system can be very large.

Specialized process control and manufacturing/production information data storage facilities (also referred to as plant historians) have been developed to handle the potentially massive amounts of time-series process/production information generated by the aforementioned systems. An example of such system is the WONDERWARE HISTORIAN. A data acquisition service associated with the historian collects time-series data values for observed parameters from a variety of data sources (e.g., data access servers). The collected time-series data is thereafter deposited with the historian to achieve data access efficiency and querying benefits/capabilities of the historian's database. Through its database, the historian integrates plant data with event, summary, production and configuration information.

Information is retrieved from the tables of historians and displayed by a variety of historian database client applications including trending and analysis applications at a supervisory level of an industrial process control system/enterprise. Such applications include graphical displays for presenting/recreating the state of an industrial process or plant equipment at any particular point (or series of points) in time. A specific example of such client application is the WONDERWARE HISTORIAN CLIENT trending and analysis application. This trending and analysis application provides a flexible set of display and analytical tools for accessing, visualizing and analyzing plant performance/status information provided in the form of streams of time-series data values for observed parameters.

Traditionally, plant databases, referred to as historians have collected and stored in an organized manner (i.e., “tabled”), to facilitate efficient retrieval by a database server, streams of time stamped time-series data values for observed parameters representing process/plant/production status over the course of time. The status data is of value for purposes of maintaining a record of plant performance and presenting/recreating the state of a process or plant equipment at a particular point in time. The tabled data comprise data points, corresponding to a named (tagged) process variables. Often each data point comprises a combination of: a value, a timestamp, and a quality (“VTQ”). Over the course of time, even in relatively simple systems, Terabytes of the steaming time stamped (e.g., VTQ) information are generated by the system and tabled by the historian.

### SUMMARY OF THE INVENTION

The present invention comprises a system and method for rendering certain types of secondary information by processing data streams rendered by a variety of data sources in a supervisory control/monitoring, process control and/or automated equipment environment. Calculations, on previously tabled data, for rendering the secondary information are performed within a database server (historian) at the time the secondary information is requested by a client of the historian that maintains a database containing the previously tabled data. By performing, by the historian, the step of creating the secondary information on demand, substantial plant historian resource savings (e.g., storage space, processor cycles) are potentially realized in comparison to a system wherein the secondary information is created on all received data for the particular types of secondary information identified below. Furthermore, by processing the received/tabled data on-demand, the calculations can be flexibly tuned for a particular purpose (through a set of output tuning parameters submitted with a request invoking a particular advanced data retrieval operation).

The historian supports an extensible set of advanced data retrieval operations. For example, an engineering units-based integral data retrieval operation transparently converts a rate to a quantity and returns the quantity to a user. Another advanced data retrieval operation is derivative/slope data retrieval operation that returns rate change values. Yet another advanced data retrieval operations includes a counter data retrieval operation that automatically handles counter rollover. Another example of an advanced data retrieval operation incorporated within the historian includes a time-in-state data retrieval operation.

The extensible nature of the historian's advanced data retrieval set ensures that as additional needs are identified, new advanced data retrieval operations are developed and incorporated within the historian's infrastructure. Client's need only specify the new advanced operations with appropriate options specified.

Moreover, the data retrieval and processing functionality of the server is enhanced by the incorporation of a filter stage that, when invoked, receives data from previously tabled control system data, and processes the received tabled data to render a filtered data set. The filtered data set is, in turn, provided to the set of advanced data retrieval operations for further processing.

In accordance with further aspects of particular embodiments, the filter stage includes computer-executable instructions for:
(1) converting a set of analog data values to a set of discrete values;
(2) removing statistical outlying data point instances based upon statistical deviation from a calculated target; and
(3) modifying data point values within a specified tolerance range of a base data point value such that data point instances falling within the range are assigned the base value.

In accordance with yet another aspect of particular embodiments, the set of advanced data retrieval operations includes a time-in-state data retrieval operation that returns a set of calculated time-in-state statistics for a data stream during a time span.

In accordance with yet anther aspect of particular embodiments, the time-in-state data retrieval operation includes a round trip calculation mode for analyzing reoccurrences of a particular state within cycles.

In accordance with yet anther aspect of particular embodiments, the time-in-state data retrieval operation includes a contained state calculation mode for limiting cyclical analysis to fully contained states within each cycle as evidenced by a transition to the state and a transition from the state within the cycle.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary networked environment wherein a process control database server embodying the present invention is advantageously incorporated;

FIG. 2 is a schematic drawing of functional/structural aspects of a historian server/service embodying the present invention;

FIG. 3a is a set of advanced data retrieval operations supported by a database server embodying the present invention;

FIG. 3b summarizes a set of calculation options supported by a “value state” retrieval mode for time-in-state retrieval wherein a “contained” option is supported for calculation of each of calculated min, max, average, total, and percent values during a cycle;

FIG. 3c summarizes a set of calculation options supported by a “round trip” retrieval mode for time-in-state retrieval wherein a series of repeated occurrences (i.e., “round trips”) of a certain state value are counted during a cycle;

FIGS. 4a and 4b graphically depict stair-step and interpolated data retrieval processing;

FIG. 5 depicts an exemplary time-sequenced set of data point values used to illustrate a derivative/slope operation;

FIG. 6 depicts an exemplary time-sequenced set of data point values used to illustrate a counter operation;

FIG. 7 depicts an illustrative sequence of data points for the purpose of demonstrating an interpolated retrieval operation;

FIG. 8 depicts an illustrative sequence of data points for the purpose of demonstrating a best fit retrieval operation;

FIG. 9 depicts an illustrative sequence of data points for the purpose of demonstrating a time weighted averaging retrieval operation;

FIG. 10 depicts an illustrative sequence of data points for the purpose of demonstrating a minimum with time retrieval operation;

FIG. 11 depicts an illustrative sequence of data points for the purpose of demonstrating a maximum with time retrieval operation;

FIG. 12 is a flow diagram depicting the general steps performed to carry out advanced data retrieval operations;

FIG. 13 is a flow diagram depicting the general steps performed to carry out filtering and advanced retrieval operations in response to a user query;

FIG. 14 summarizes a set of data filters used to pre-process raw data point streams prior to processing by advanced data retrieval operations; and

FIG. 15 illustratively depicts the filtering performed by a statistical filter.

### DETAILED DESCRIPTION OF THE DRAWINGS

As noted previously in the background, plant information historian servers/services maintain a database comprising a wide variety of plant status information. The plant status information, when provided to operations managers in its unprocessed form, offers limited comparative information—such has how a process or the operation of plant equipment has changed over time. In many cases, performing additional analysis on received/tabled data streams to render secondary information greatly enhances the information value of the received/tabled data. In embodiments of the invention, such analysis is delayed until a client requests such secondary information from the historian service for a particular timeframe. As such, limited historian memory/processor resources are only allocated to the extent a client of the historian service has requested the secondary information. In particular, the historian service supports a set of advanced data retrieval operations wherein received/tabled data is processed to render particular types of secondary information “on demand” and in response to “client requests.”

The term “tabled” is used herein to describe data, received by a database server/historian, stored in an organized manner to facilitate efficient retrieval by the database server.

The terms “client requests” and “on demand” are intended to be broadly defined. The process/plant historian service embodying the present invention does not distinguish between requests arising from human users and requests originating from automated processes. Thus, a “client request”, unless specifically noted, includes requests initiated by human machine interface users and requests initiated by automated client processes. The automated client processes potentially include processes running on the same node as the historian service. The automated client processes request the secondary information and thereafter provide the received secondary information, in a service role, to others. Furthermore, the definition of “on demand” is intended to include both providing secondary information in response to specific requests as well as in accordance with a previously established subscription. By performing the calculations to render the secondary information on demand, rather than calculating (and tabling) them without regard to whether they will ever be requested by a client, the historian system embodying the present invention is better suited to support a very broad/extensible set of secondary information types meeting diverse needs of a broad variety of historian service clients.

In an embodiment of the present invention, the historian service supports a variety of advanced retrieval operations for calculating and providing, on demand, a variety of secondary information types from data previously tabled in the historian database. Among others, the historian service specifically includes the following advanced data retrieval operations: “time-in-state”, “counter”, “engineering units-based integral”, and “derivative”. “Time-in-state” calculations render statistical information relating to an amount of time spent in specified states. Such states are represented, for example, by identified tag/value combinations. By way of example the time-in-state statistics include, for a specified time span and tagged state value: total amount of time in the state, percentage of time in the state, the average time in state, the shortest time in the state, and the longest time in the state.

With regard to the “counter” advanced data retrieval operation, it is noted that some instance counters “rollover” (i.e., return to zero) after reaching a particular count value. For example, a 4-digit decimal integer counter counts from zero to 9999 before rolling over to a zero value. The counter advanced data retrieval operation operates upon stored counter data to convert unprocessed counter readings into a meaningful summary of the amount of increase measured by the counter (whether real or integer) over time, factoring in any rollover and inferring rollover even if a rollover value (e.g., a rollover counter) itself is not directly sampled.

With regard to the “engineering units-based integral” advanced data retrieval operation, instantaneous measurement data is sampled and processed over a user-specified time period. Rather than use a fixed time unit (e.g., seconds only), the EU-based integral retrieval operation uses the time unit specified by the tabled data samples (e.g., liters/minute, liters/second, etc.) to render a quantity for the specified time period. The “derivative” advanced data retrieval operation involves calculating estimates of the instantaneous rate of change for a specified time span to render a time series sequence of data values reflecting the dynamic (i.e., changing) aspect of a particular received/tabled data stream. Each of the above advanced retrieval modes is described in detail herein below in association with an exemplary system including a historian server/service incorporating the above-identified advanced data retrieval operations.

The functionality of above-mentioned retrieval operations are further expanded through enhancements to previously supported time-in-state retrieval operations. In particular, a “contained” option excludes, during time-in-state retrieval calculations, states of a specified tag that are not fully contained inside of a calculation cycle (e.g. for an hourly cycle, excluding from a cycle ending at 8:00:00, an instance of a tag state where a change of the tag to the particular state occurred at 7:59.00, and the tag did not change to a subsequent state until 8:05:00—after the end of the hourly cycle). Also, a “round trip” retrieval mode of a time-in-state retrieval operation performs calculations for each time cycle, where each round trip for specified state is measured according to a time when a tag enters a specified state to a later time when the tag returns to the specified state.

The functionality of retrieval operations is further enhanced by providing a set of retrieval filters that operate upon a set of retrieved data values prior to performing calculations on a retrieved data set in accordance with advanced data retrieval operations described herein. The set of retrieval filters include, by way of example, statistical (e.g., standard deviation-limited), snapto (a base value when value is within a specified tolerance of the base value), and analog-to-discrete (the discrete value being, for example, from the set of potential values true/false/NULL). In an exemplary embodiment, the retrieval filters are provided in the form of an extensible set of add-on modules to an existing system. Moreover, the add-on modules can be dynamically loaded (e.g., at startup, on demand, etc.). Thus, the set of retrieval filters can be easily expanded to include new retrieval filters.

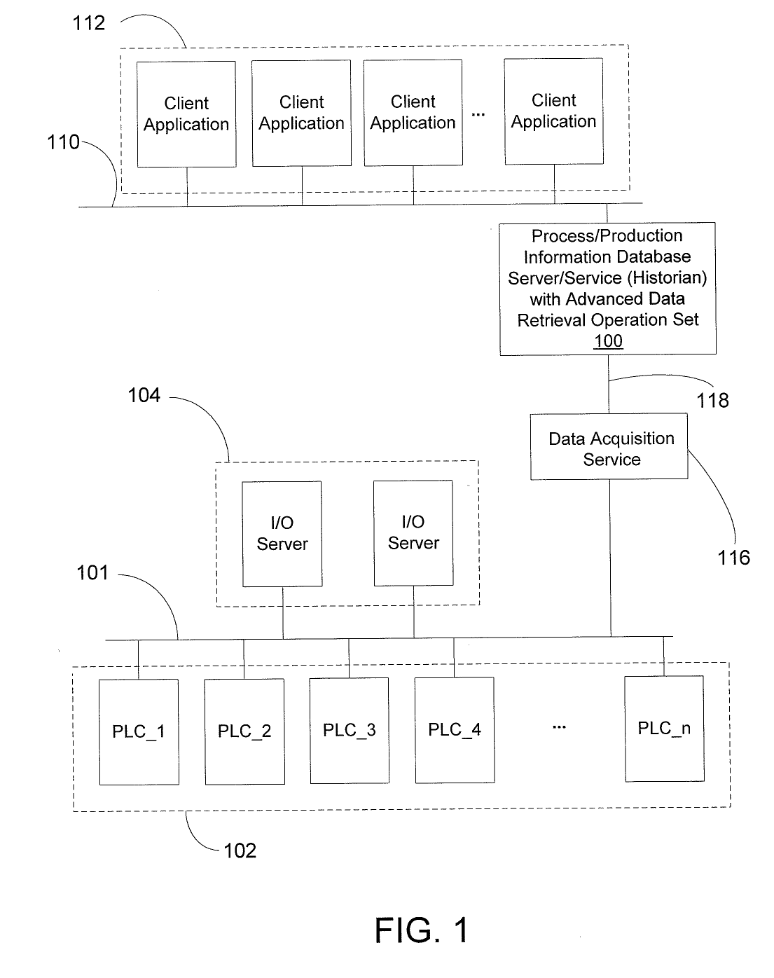

The following description is based on illustrative embodiments of the invention and should not be taken as limiting the invention with regard to alternative embodiments that are not explicitly described herein. Those skilled in the art will readily appreciate that the illustrative example in FIG. 1 represents a simplified configuration used for illustrative purposes. In particular, the systems within which the present invention is incorporated are substantially larger and the breadth of network connections to client applications greater (including clients that access the historian via an Internet portal server). While the illustrative network arrangement depicts a local area network connection between a historian and a set relatively small number of data sources. In many instances, the number of data sources is several times larger—resulting in massive quantities of time-series process data associated with potentially hundreds and even thousands of data points in a process control system. Notwithstanding the recent improvements in secondary storage capacity, reducing the quantity of data by reducing the types of data stored, thereby reducing the size of files associated with tabled process data points, potentially improves the performance of the historian and its clients.

FIG. 1 schematically depicts an illustrative environment wherein a supervisory process control and manufacturing/production information data storage facility (also referred to as a plant historian) 100 embodying the present invention is potentially incorporated. The historian 100 includes database services for maintaining and providing a variety of plant/process/production information including historical plant status, configuration, event, and summary information.

The network environment includes a plant floor network 101 to which a set of process control and manufacturing information data sources 102 are connected either directly or indirectly (via any of a variety of networked devices including concentrators, gateways, integrators, interfaces, etc.).

While FIG. 1 illustratively depicts the data sources 102 as a set of PLCs(1-N), the data sources 102 comprise any of a wide variety of data sources (and combinations thereof) including, for example, programmable logic controllers (PLCs), input/output modules, and distributed control systems (DCSs). The data sources 102, in turn, are coupled to, communicate with, and control a variety of devices such as plant floor equipment, sensors, and actuators. Data received from the data sources 102 potentially represents, for example, discrete data such as states, counters, events, etc. and analog process data such as temperatures, tank levels/pressures, volume flow, etc. A set of I/O servers 104, for example DATA ACCESS SERVERS developed and provided by WONDERWARE, acquire data from the data sources 102 via the plant floor network 101 on behalf of a variety of potential clients/subscribers—including the historian 100.

The exemplary network environment includes a production network 110. In the illustrative embodiment the production network 110 comprises a set of client application nodes 112 that execute, by way of example, trending applications that receive and graphically display time-series values for a set of data points. One example of a trending application is WONDERWARE'S ACTIVE FACTORY application software. The data driving the trending applications on the nodes 112 is acquired, by way of example, from the plant historian 100 that also resides on the production network 110. The historian 100 includes database services for maintaining and providing a variety of plant/process/production information including historical plant status, configuration, event, and summary information.

A data acquisition service 116, for example WONDERWARE'S REMOTE IDAS, interposed between the I/O servers 104 and the plant historian 100 operates to maintain a continuous, up-to-date, flow of streaming plant data between the data sources 102 and the historian 100 for plant/production supervisors (both human and automated). The data acquisition service 116 acquires and integrates data (potentially in a variety of forms associated with various protocols) from a variety of sources into a plant information database, including time stamped data entries, incorporated within the historian 100.

The physical connection between the data acquisition service 116 and the I/O servers 104 can take any of a number of forms. For example, the data acquisition service 116 and the I/O servers 104 can comprise distinct nodes on a same network (e.g., the plant floor network 110). However, in alternative embodiments the I/O servers 104 communicate with the data acquisition service 116 via a network link that is separate and distinct from the plant floor network 101. In an illustrative example, the physical network links between the I/O servers 104 and the data acquisition service 116 comprise local area network links (e.g., Ethernet, etc.) that are generally fast, reliable and stable.

The connection between the data acquisition service 116 and the historian 100 can also take any of a variety of forms. In an embodiment of the present invention, the physical connection comprises an intermittent/slow connection 118 that is potentially: too slow to handle a burst of data, unavailable, or faulty. The data acquisition service 116 and/or the historian therefore include components and logic for handling the stream of data from components connected to the plant floor network 101. In view of the potential throughput/connectivity limitations of connection 118, to the extent secondary information is to be generated/provided to clients of the historian 100 (e.g., nodes 112), such information should be rendered after the data has traversed the connection 118. In an embodiment, the secondary information is rendered by advanced data retrieval operations incorporated into the historian 100.

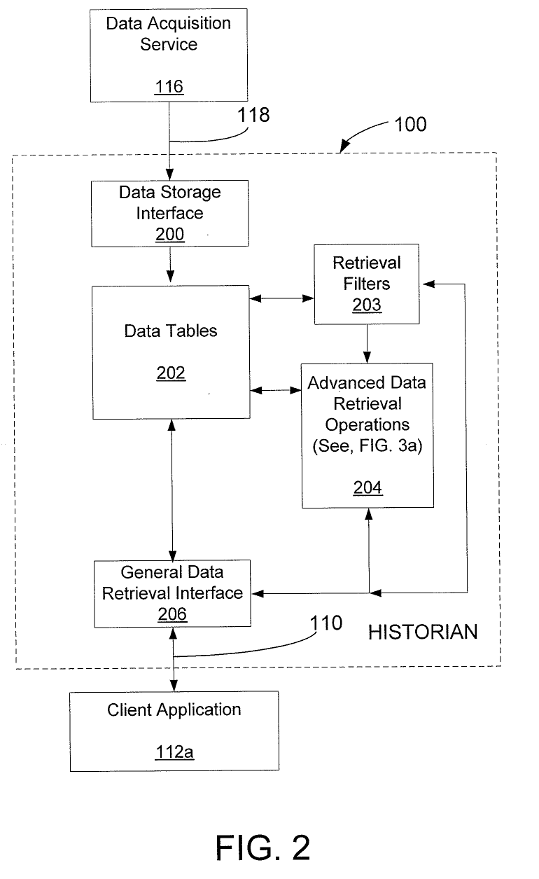

Turning to FIG. 2 an exemplary schematic diagram depicts functional components associated with the historian 100. The historian 100 generally implements a storage interface 200 comprising a set of functions/operations for receiving and tabling data from the data acquisition service 116 via connection 118. The received data is stored in one or more tables 202 maintained by the historian 100.

By way of example, the tables 202 include pieces of data received by the historian 100 via a data acquisition interface to a process control/production information network such as the data acquisition service 116 on network 101. In the illustrative embodiment each piece data is stored in the form of a value, quality, and time stamp. These three parts to each piece of data stored in the tables 202 of the historian 100 is described briefly herein below.

### Timestamps

The historian 100, tables data received from a variety of “real-time” data sources, including the I/O Servers 104 (via the data acquisition service 116). The historian 100 is also capable of accepting “old” data from sources such as text files. By way of example, “real-time” data can be defined to exclude data with timestamps outside of ±30 seconds of a current time of a clock maintained by a computer node hosting the historian 100. However, data characterizing information is also addressable by a quality descriptor associated with the received data. Proper implementation of timestamps requires synchronization of the clocks utilized by the historian 100 and data sources.

### Quality

The Historian 100 supports two descriptors of data quality: “QualityDetail” and “Quality.” The Qualitydescriptor is based primarily on the quality of the data presented by the data source, while the QualityDetail descriptor is a simple indicator of “good”, “bad” or “doubtful”, derived at retrieval-time. Alternatively, the historian 100 supports an OPCQuality descriptor that is intended to be used as a sole data quality indicator that is fully compliant with OPC quality standard(s). In the alternatively embodiment, the QualityDetail descriptor is utilized as an internal data quality indicator.

### Value

A value part of a stored piece of data corresponds to a value of a received piece of data. In exceptional cases, the value obtained from a data source is translated into a NULL value at the highest retrieval layer to indicate a special event, such as a data source disconnection. This behavior is closely related to quality, and clients typically leverage knowledge of the rules governing the translation to indicate a lack of data, for example by showing a gap on a trend display.

The following is a brief description of the manner in which the historian 100 receives data from a real-time data source and stores the data as a timestamp, quality and value combination in one or more of its tables 202. The historian 100 receives a data point for a particular tag (named data value) via the storage interface 200. The historian compares the timestamp on the received data to: (1) a current time specified by a clock on the node that hosts the historian 100, and (2) a timestamp of a previous data point received for the tag. If the timestamp of the received data point is earlier than, or equal to the current time on the historian node then:
If the timestamp on the received data point is later than the timestamp of the previous point received for the tag, the received point is tabled with the timestamp provided by the real-time data source.
If the time stamp on the received data point is earlier than the timestamp of the previous point received for the tag (i.e. the point is out of sequence), the received point is tabled with the timestamp of the previously tabled data point “plus 5 milliseconds”. A special QualityDetail value is stored with the received point to indicate that it is out of sequence (the original quality received from the data source is stored in the “quality” descriptor field for the stored data point).

On the other hand, if the timestamp of the point is later than the current time on the historian 100's node (i.e. the point is in the future), the point is tabled with a time stamp equal to the current time of the historian 100's node. Furthermore, a special value is assigned to the QualityDetail descriptor for the received/tabled point value to indicate that its specified time was in the future (the original quality received from the data source is stored in the “quality” descriptor field for the stored data point).

The historian 100 can be configured to provide the timestamp for received data identified by a particular tag. After proper designation, the historian 100 recognizes that the tag identified by a received data point belongs to a set of tags for which the historian 100 supplies a timestamp. Thereafter, the time stamp of the point is replaced by the current time of the historian 100's node. A special QualityDetail value is stored for the stored point to indicate that it was timestamped by the historian 100. The original quality received from the data source is stored in the “quality” descriptor field for the stored data point.

It is further noted that the historian 100 supports application of a rate deadband filter to reject new data points for a particular tag where a value associated with the received point has not changed sufficiently from a previous stored value for the tag.

Having described a data storage interface for the historian 100, attention is directed to retrieving the stored data from the tables 202 of the historian 100. Access, by clients of the historian 100, to the stored contents of the tables 202 is facilitated by a retrieval interface 206. The retrieval interface 206 exposes a set of functions/operations/methods (including a set of retrieval filters 203 and a set of advanced data retrieval operations 204), callable by clients on the network 110 (e.g., client applications on nodes 112), for querying the contents of the tables 202.

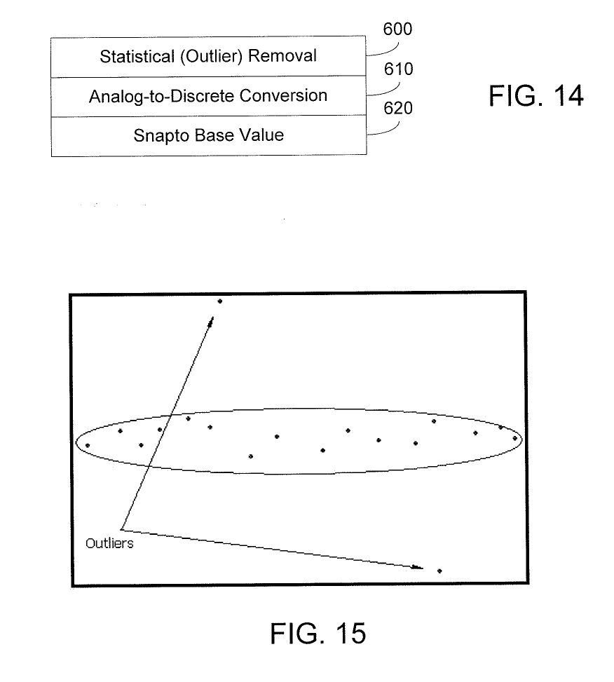

The retrieval filters 203 optionally pre-process raw VTQ data streams obtained from the tables 202 to render a modified (filtered) VTQ stream. The modified VTQ steam is thereafter: (1) further processed by performing one of the described advanced data retrieval operations (204), and/or (2) forwarded via the data retrieval interface 206 to a client application (e.g., a historic data display monitor that displays a data stream, or streams, for a designated time period). The various processing paths of retrieved data are illustratively depicted by the lines connecting the tables 202, retrieval filters 203, advanced data retrieval operations 204, and the retrieval interface 206. In systems that cannot filter (see, filters 203) the raw VTQ data streams before carrying out advanced retrieval operations (see, retrieval operations 204), erroneous results are potentially provided. For example, a transient spike in a particular value could lead to an inaccurate portrayal of a process' range of operation for a particular parameter (e.g., pressure, temperature, flow, etc.). An exemplary set of retrieval filters is described herein below with reference to FIG. 14.

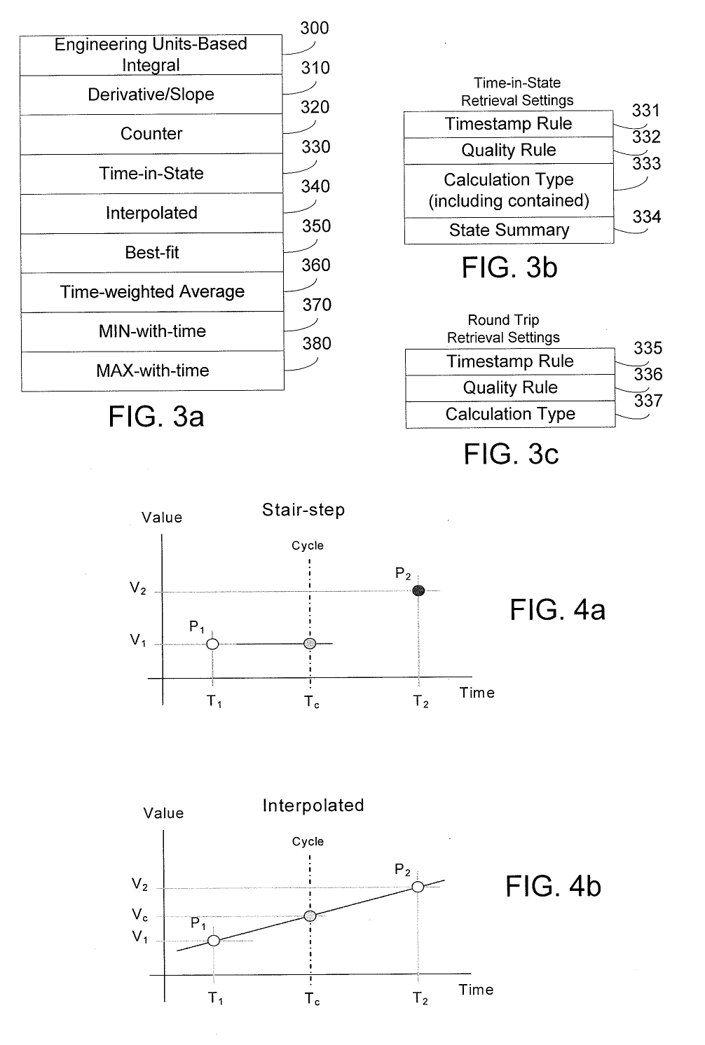

The advanced data retrieval operations 204 generate secondary information, on demand, by post processing data stored in the tables 202. In response to receiving a query message identifying one of the advanced data retrieval options carried out by the operations 204, the retrieval interface 206 invokes the identified one of the set of advanced data retrieval operations 204 supported by the historian 100. An exemplary set of operations included in the advanced data retrieval operations 204 are enumerated in FIG. 3a described herein below.

Turning to FIG. 3a, in addition to known/standard delta, full and cyclic data retrieval modes an exemplary set of advanced data retrieval modes are supported by the historian 100. The advanced data retrieval modes, adding post processing to rows of data (corresponding to stored data value points) retrieved from the tables 202 of the historian 100, are facilitated by the set of advanced data retrieval operations 204 enumerated in FIG. 3a. The set of operations are capable of operating on rows of data (grouped as cyclic buckets) associated with a single, specific tag, or alternatively a set of specified tags. Furthermore, in addition to specifying a time period over which the operation is to occur, a client potentially specifies particular options (e.g., interpolation method) for customizing completion of an operation on a tag-specific basis. Furthermore, in the illustrative embodiment each of the retrieval operations is implemented as a distinct object class from which instances are created and started either at start-up, or alternatively, upon the historian receiving a particular type of advanced data retrieval request.

In an exemplary embodiment, the advanced retrieval operations support options for tailoring data retrieval and processing tasks performed by the operation in response to a requesting client. Options specified in a request invoking a particular advanced retrieval operation include, for example, an interpolation method, a timestamp rule, and a data quality rule. Each of these three options is described herein below.

With regard to the interpolation method option, wherever an estimated value is to be returned to a requesting client for a particular specified time, the returned value is potentially determined in any of a variety of ways. In an illustrative example, the advanced retrieval operations support stair-step and linear interpolation. In the stair-step method, the operation returns the last known point, or a NULL if no valid point can be found, along with a cycle time with which the returned stair-step value is associated. Turning to the example illustrated in FIG. 4a, where a retrieval operation receives a request for a “stair-step” value for a cycle having a boundary at time T_{c}, and the most recent point stored for the tag is P₁, the operation extends the last stored value assigned at P₁ and returns the value V₁ at time T_{c}.

Alternatively, linear interpolation is performed on two points to render an estimated value for a specified time. Turning to the example illustrated in FIG. 4b, where a retrieval operation receives a request for a linearly interpolated value for a cycle boundary at time T_{c}, and the most recently stored point for the tag is P₁, and the first point stored beyond T_{c} is P₂, the operation linearly interpolates between points P₁, and P₂. It is possible that one of the points will have a NULL value. If either of the points is NULL value, then P₁ is returned at time T_{c}. If both points are non-NULL, then the value V_{c} is returned as the value where the line through both points intersects with the cycle boundary, and the value V_{c} at time T_{c} is returned to the client. Expressed in a formula V_{c} is calculated as:

V_{c}=V₁+((V₂−V₁)*((Tₐ−T₁)/(T₂−T₁)))

for (T₂−T₁)≠0.

In an exemplary embodiment, whether the stair-step method or linear interpolation is used by an advanced retrieval operation specifying a given tag is determined, if not overridden, by a setting on the tag. If the setting is ‘system default’, then the system default is used for the tag. A client can override a specified system default for a particular query and designate stair-step or linear interpolation for all tags regardless of how each individual tag has been configured.

The data quality rule option on an advanced retrieval operation request controls whether points with certain characteristics are explicitly excluded from consideration by the algorithms of the advanced retrieval operations. By way of example, a client request optionally specifies a data quality rule, which is handed over to a specified advanced data retrieval operation. A client optionally specifies a quality rule (e.g., reject data that does not meet a particular quality standard in a predetermined scale). If no quality rule option is specified in a client request, then a default rule (e.g., no exclusions of points) is applied. In an exemplary embodiment, the client specifies a quality rule requiring the responding operation to discard/filter retrieved points having doubtful quality—applying an OLE for process control (OPC) standard. The responding operation, on a per tag basis, tracks the percentage of points considered as having good quality by an algorithm out of all potential points subject to a request, and the tracked percentage is returned to the client.

The time stamp rule option applied to an advanced data retrieval request controls whether cyclic results are time stamped with a time marking the beginning of a cycle or the end of the cycle. In an illustrative example, a client optionally specifies a time stamp rule, and the time stamp is handed over to the operation. Otherwise, if no parameter is specified, then a default is applied to the advanced retrieval operation.

Turning to the set of operations listed in FIG. 3a, an engineering units-based integral operation 300 calculates values to be provided by the historian 100 to a requesting client over a period of time (e.g., at cycle boundaries) by integrating a set of instantaneous values provided by previously stored data points stored for a tag over the period. Once invoked upon a particular tag or tags, the integral operation 300, by way of example, renders output cyclically (e.g., every second, minute, etc.) to the requesting client for a period specified in the query. In the exemplary embodiment, the integral operation can only be specified for an analog tag.

In an embodiment wherein the integral operation 300 renders output for each cycle (the length of which is specified by either a resolution/duration value or a number of cycles in a period—such as a day), the integral operation 300 initially calculates the “area under the curve” based upon a set of values stored for an analog tag over a cycle/period—using the specified resolution parameter to guide the process of retrieving data point values. After determining the area under the curve, the result is scaled using a specifically designated integral devisor for the particular tag. In an illustrative embodiment, the integral devisor is stored in a referenced entry in an engineering unit table. The designated integral divisor expresses a conversion factor from the actual rate to one of units over a designated standard period (e.g., second). Thus, during execution of the integral operation 300 instantaneous rate measurements are converted into a quantity over a specified time span. However, rather than basing the conversion on a fixed time (e.g., seconds) divisor, the integral operation 300 uses a time basis used by the stored data points (and specified in the engineering unit table) and performs an appropriate conversion by referencing a conversion value stored in the engineering unit table in the historian 100. The engineering unit value conversion step renders the time-units of the original data points, from which the integral is determined, transparent to a requesting client of the historian 100. For example, the engineering units-based integral operation makes it possible to compare results from two separately rendered sets of volume flow measurements wherein the first set of measurements are expressed in “liters/sec” and a second set of measurements is expressed in “liters/min”. The operation 300 applies a conversion factor specified by a tag associated with each of the two measurements and renders both results in the form of “liters.” This contrasts with known integral operation implementations that require the client to know how (and remember) to convert from hard-coded reference units (if seconds, divide the integral results of the “liters/min” measure by 60) to implement the comparison.

While the integral operation 300 described above is performed cyclically. In alternative embodiments the integral operation 300 is called by the client with a specified start and stop time. The integral operation 300 returns a value to the requesting client corresponding to a measured quantity over the time period without a time-basis.

A derivative/slope operation 310 calculates a series of instantaneous rate of change estimates for a set of point values for an identified tag within a specified time span. By way of example, the derivative/slope operation 310 generates a rate of change estimate, for each stored tag value of interest, based upon observation of one or more point values adjacent to the tag value of interest. In a specific implementation of the derivative/slope operation 310, the rate of change estimate for a particular point value is determined by calculating a difference between the particular point value and the immediately preceding point value, and dividing by an elapsed time period between the two stored point values. However, the derivative/slope operation 310 can be estimated through alternative methods including using other point value combinations (e.g., current point and immediately subsequent point) and estimation techniques (e.g., curve fitting). In an exemplary embodiment, a “quality” option instructs the derivative/slope operation 310 to disregard points identified as having doubtful quality.

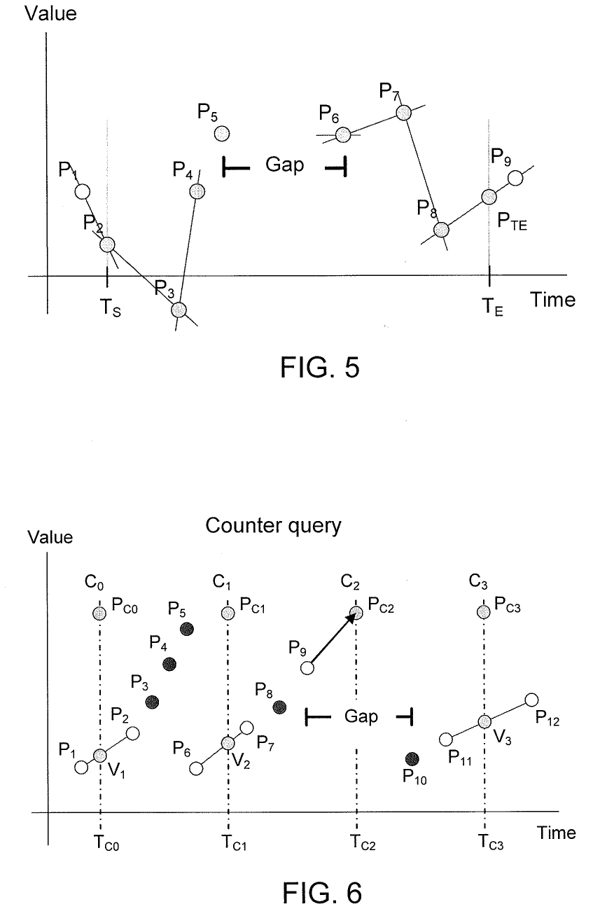

The derivative/slope operation 310 returns the calculated derivative/slope values in chronological order. Turning to FIG. 5, a graphical example of a data set acted upon by the derivative/slope operation 310 is provided. In this case a set of values associated with a single tag are processed over a time period starting at T_{S} and ending at T_{E}. In the illustrative example, nine points of tabled data are retrieved for the identified tag and period. The points are represented by dots marked P₁ through P₉. Of the nine points, eight represent normal analog values. However, P₅ represents a NULL value arising from an I/O server disconnect that created an absence of data between points P₅ and P₆. As previously explained, the derivative/slope operation 310 calculates, for each data point falling within the specified period, the slope of the line going through the data point of interest and the data point immediately prior to it. In an illustrative embodiment, the data points are calculated and returned for a one second delta change in time.

Furthermore, points outside the specified time period are utilized to calculate the slopes at the specified time period boundaries. Point P₂ in FIG. 5 is located at the query start time, and because a qualifying prior point P₁ exists, a slope for point P₂ (at time T_{S}) corresponds to the line drawn through the two points. The derivative/slope operation 310 calculates a slope for point P₂ (at time T_{S}) according to the following formula: S(T_{S})=(P₂−P₁)/(T₂−T₁). Similar slope calculations are performed to render slopes for points P₃, P₄, P₇, and P₈. A final slope is calculated for a calculated point P_{TE} at time T_{E} using the values and timestamps associated with points P₈ and P₉.

With regard to the handling of NULL values, no calculated slope value exists for point P₆ due to the NULL value associated with point P₅—the prior point that would otherwise be used to calculate a slope value. Instead of returning a slope value at point P₆, as depicted by the flat line through the point, a slope value of zero is returned. A slope value of NULL is returned for time T₅ (corresponding to point P₅ having a NULL value).

A counter retrieval operation 320 uses a tag's rollover point to calculate and return a delta change over a period of time (e.g., between consecutive cycles as defined by a resolution/timespan for each cycle or a cycle count equal to the number of measurements taken every 24 hours). The counter retrieval operation 320 can be used to calculate a number of items passing through a production line using a counter register that potentially rolls-over during a relatively predicable/foreseeable finite period. The counter retrieval operation 320 operates in a cyclic mode wherein a counter-compensated delta value is returned for each tag (in a client's query) for each cycle. The counter retrieval operation 320 provided a series of cyclically rendered delta values for a tag based upon a specified cycle duration/resolution which is indirectly specified by a number of cycles within a period (e.g., one day). The counter retrieval operation 320, in essence extends the range of a counter of limited size that is subject to relatively frequent rollover and would otherwise provide inaccurate delta value data over time. Alternatively, in the case of a counter that is reset before reaching a maximum value (prior to rollover), the highest retrieved data point value before resetting the counter is treated as the “maximum” count value.

Turning to FIG. 6, an exemplary set of twelve previously tabled data points for a specified tag are graphically depicted to illustrate the functionality of the counter retrieval operation 320. In the example depicted in FIG. 6, the counter retrieval operation 320 is executed based upon a query start time of T_{C0} and an end time of T_{C3}. In the illustrative example, the query resolution has been set such that the operation 320 returns data for three complete cycles starting at T_{C0}, T_{C1} and T_{C2} and returns an incomplete cycle starting at time T_{C3}. In the illustrative example the twelve points in the cycles of interest are represented by the points marked P₁ through P₁₂. Of these points eleven represent normal analog values, and one, P₉, represents a NULL due to an I/O server disconnect, which causes a gap in the data between stored data points P₉ and P₁₀. All points are found and considered by the counter retrieval logic, but only stored points P₁, P₂, P₆, P₇, P₉, P₁₁ and P₁₂, and three interpolated points V₁, V₂, and V₃ are used to determine values to return to the requesting client. In the illustrative example, the counter retrieval operation 320 returns points P_{C0}, P_{C1}, P_{C2} and P_{C3} shown at the top to indicate that there is no simple relation between these calculated points and the actual stored data points from which they are calculated.

An ‘initial value’ to be returned at the query start time is not a simple stair-step or interpolated value. The initial value is calculated just like all other cycle values as the delta change between the cycle time in question and a value calculated during a previous cycle—taking into account a rollover, if any, that occurred between the two points in time.

With regard to utilizing the counter operation 320 to render values for a requesting client, take for example the calculation of the value P_{C1}. The rollover point for the queried tag has been set to a value V_{R}, the interpolation type has been set to linear interpolation, and the timestamp rule has been set for the results to be timestamped at the end of the cycle. First interpolation is performed by the counter retrieval operation 320 to find values V₁ and V₂ at a first and second cycle boundary. Assuming that both sets of values pass a quality rule test, a calculation is performed on the interpolated values V₁ and V₂ to determine a counter value.

By way of example, if n rollovers have occurred during the course of a single cycle, then the counter-compensated delta (difference) difference between a tag value at time T_{C0} and time T_{C1} is defined as follows:

P_{C1}=n*V_{R}+V₂−V₁

Thus, if n is zero, we just calculate the difference between the values V₂ and V₁.

NULLs, by way of example, are handled in a number of ways. In the case of cycle C₂ we have no value at the cycle time. The counter retrieval operation 320 returns a NULL value represented by point P₉. In the case of cycle C₃ a NULL value is returned because there is no counter value at the previous cycle boundary to plug into the above formula. If a gap is fully contained inside a cycle, and if valid data points exist within the cycle on both sides of the gap, then a counter value is returned even though it may occasionally be erroneous—as zero or one rollovers are assumed when in-fact the counter may have rolled over multiple times.

Yet another form of advanced retrieval is carried out by a time-in-state retrieval operation 330. The time-in-state retrieval operation 330 returns to a requesting client a variety of collective/aggregate information about the length of time that a specified tag attribute/portion (e.g., value, quality, quality detail, etc.) has been designated as occupying each of a set of possible states. The time-in-state retrieval operation 330 calculates statistics on the amount of time spent in the states represented by distinct tag values and returns the results to a requesting client.

By way of example, a client issues a time-in-state query to the historian 100 specifying a tag (or set of tags) and a portion of the tag information (e.g., value, quality, etc.) for which time-in-state information is desired. The query specifies a time period for which the requested time-in-state information is desired (e.g., one cycle, start/stop time, etc.). In an illustrative example, a resolution (duration of each cycle) is specified which determines a set of cycles into which the query time period is divided when rendering results. A set of requested information is returned for each cycle within a time period covered by a query. A time-in-state query also optionally specifies a timestamp rule—determining the relevant timestamp assigned to the query results for a cycle (e.g., the end time of the cycle). A query also specifies a quality rule/filter. An embodiment of the invention supports a set of time-in-state aggregation types (described in detail below). Thus, a client's time-in-state query to the historian 100 also specifies one or more aggregation methods to be applied to retrieved data to render responsive time-in-state information.

The advanced retrieval operations are invoked in a variety of ways. In an illustrative example, the operations are invoked as OLE extensions to a standard/base SQL database interface. In an alternative example wherein one or more of the advanced retrieval operations are implemented by object instances (e.g., COM/DCOM objects), the historian 100 invokes the time-in-state retrieval operation 330 through a call to an object instance for calculating and retrieving time-in-state information specified by the received client query.

The time-in-state retrieval operation 330 returns a set of accumulated time-in-state information for a specified tag's value (or separately specifiable values under a tag) during each cycle (e.g., each hour, shift, day, week, etc.). Examples of supported tag value data types for time-in-state retrieval include: integer, discrete (e.g., Boolean plus NULL support, a spectrum of input values divided into a set of distinct/continuous/non-overlapping ranges—each range being assigned a distinct value), and string. Any tag/variable with a substantially limited number of possible values is suitable for time-in-state retrieval. Thus, for example, values of an analog tag can be used to generate a recorded stream of discrete range (e.g., high, medium, low) values for a discrete tag for purposes of time-in-state analysis. Responses to time-in-state queries are based upon the occupation of particular “value” states of a specified tag during a particular cycle as evidenced by the timestamps and values of data points retrieved for the tag during the cycle.

With continued attention to the content of a query to the historian 100 to initiate the time-in-state retrieval operation 330, the illustrative embodiment supports client requests specifying a variety of time-in-state data aggregation types. The aggregation types include: minimum, maximum, average, total, and percent. In the case of a minimum time-in-state request, the time-in-state operation 330 returns a time-wise shortest occurrence of each distinct value for a specified tag within a time period (e.g., a cycle of interest). Similarly, a maximum time-in-state request returns a time-wise longest occurrence of each distinct value for a specified tag within a time period. An average time-in-state request returns an average time-wise duration of occurrences of each distinct value for a specified tag within a time period. In the case of a total time-in-state request, the time-in-state retrieval operation 330 returns the total time-wise occurrence of each distinct value for a specified tag within a time period. A percent time-in-state request results in the time-in-state retrieval operation 330 returning the percentage of the time period (e.g., cycle) spent in each distinct value for a specified tag. It is noted that while the above described operation operates on a single tag, embodiments of the historian 100 support queries specifying multiple tags and/or multiple returned time-in-state aggregate data types.

Turning to FIGS. 3b and 3c, enhancements, in the form of two new retrieval modes, to the above-described time-in-state retrieval operation 330 are presented. The time-in-state retrieval operation 330 enhancements extend the functionality of query-time calculations supported for: discrete, integer, and string tags. The enhanced analytical computation functionality of the time-in-state retrieval operation 330 includes:
1. “round trip” time-in-state calculations for each time cycle, where each round trip for specified state is measured according to a time when a tag enters a specified state to a later time when the tag returns to the specified state; and
2. “contained” state calculations that exclude, for each time cycle, states of a specified tag that are not fully contained inside of a calculation cycle (e.g. for an hourly cycle, excluding from a cycle ending at 8:00:00, an instance of a tag state where a change of the tag to the particular state occurred at 7:59.00, and the tag did not change to a subsequent state until 8:05:00—after the end of the hourly cycle).

The “round trip” mode is used to potentially optimize production cycle times in a process. Assuming for example that a process produces one item per “round trip” (marked by a “finished” state), then the round trip time-in-state can be used to measure a variety of parameters relating to how often the “finished” state is revisited during each cycle (e.g., hour). The “contained” calculation is used, for example, to ensure that states are properly measured when an average duration of the state is of interest. In such cases, counting “partially contained” states could substantially affect accuracy of an “average” duration of a particular state during a cycle of interest.

Turning to FIG. 3b, a set of settings/options are enumerated for defining a value state retrieval mode, the first of two retrieval modes of the time-in-state retrieval operation 330 described herein. The value state retrieval mode performs summarization operations on discrete tags having a relatively limited number of states—as opposed to analog values that can be assigned any of a relatively large number of (digitized) values. As noted generally above for the time-in-state retrieval operation 330, value state retrieval is supported for tags having a limited number of values (“states”). Thus suitable tag types include: integer tags, discrete (Boolean) tags, string tags, state summary tags, and analog tags converted according to grouping criteria (e.g., range designations) to occupy one of a limited number of supported values.

The value state retrieval mode of the time-in-state retrieval operation 330 retrieves a set of values (corresponding to states) for a tag over a given cycle and analyzes various aspects of the set of discrete values relating to the amount of time spent in the limited number of states based upon retrieval settings (see, FIG. 3b retrieval settings discussed herein below). For example, a simple discrete tag set to ON, when a process or sub-process is active, and to OFF, when the process is stopped, is potentially used analyze process down time. The value state retrieval mode of the time-in-state retrieval operation 330 is a cyclic retrieval mode, and thus the set of values for a tag are analyzed by the value state retrieval mode (of the time-in-state retrieval operation 330) over a cycle (e.g., one hour, one shift, one day, etc). Value state retrieval has no special NULL handling—a NULL tag value is treated as distinct one of the possible values for a given tag.

Value State Retrieval Mode Settings

The exemplary value state retrieval mode supports designating a variety of options to tailor the retrieval of data (including filtering) and specify calculations performed on the resulting data sets to render particular analytical summaries for particular discrete/state tags.

The value state retrieval mode includes a time stamp rule option 331 that assigns a timestamp for a given cycle that corresponds to either a start or end time for the cycle.

The value state retrieval mode includes a quality rule option 332 that specifies a filter for only using values (points) for a given tag that meet a specified quality level. By default, no quality rule is applied. An example of a quality level is “Good” wherein points assigned a “doubtful” quality status are not considered for state value calculations.

The value state retrieval mode includes a calculation type option 333 that specifies the type of summary calculation to be performed during execution of a time-in-state retrieval operation 330 operating in the value state mode. In the illustrative example, the following “calculation type” options are supported: Minimum, Maximum, Average, Total, Percent, MinContained, MaxContained, AvgContained, TotalContained, PercentContained. Each of the calculation type options are described herein below. For each calculation type, summaries are potentially generated for: (1) each supported state of a tag, and (2) each cycle. If a period containing multiple summary cycles (e.g., specified by a “Resolution” summary parameter) is specified, then the returned calculations are specified separately for each summary cycle (e.g., if the cycle is one hour and the time period is one day, then 24 separate summaries are rendered). A “state summary” setting 334, described below, aggregates the aforementioned value state summary calculations over a specified time period including multiple summary cycles (specified by a “resolution” parameter in a query).

An example of a query for submitting a value state retrieval request is provided below.

SELECT TagName, DateTime, Value, StateTime, QualityDetail
FROM History
WHERE TagName IN (‘Welder1’,‘Welder2’)
AND wwRetrievalMode = ‘ValueState’’
AND wwStateCalc = ‘Total’
AND wwResolution = 3600000
AND DateTime >= ‘20100513 00:00:00.000’
AND DateTime <= ‘20100514 00:00:00.000’

In the above example, the retrieval mode is ValueState (corresponding to a query as described herein above with reference to FIG. 3b). The “Resolution” parameter indicates that a summary is calculated every hour (3600000 milliseconds). Moreover, the “Total” calculation type is specified, and the target tags of the retrieval request are Welder1 and Welder2.

In general “contained” value state calculation types are performed in the same way as “non-contained” calculations. However, “contained” calculations omit occurrences of a particular state that either begin or end outside a cycle—and thus are not fully contained inside any calculation cycle. Whether a state is contained is determined, for example, by determining a tag's final value for a cycle preceding a cycle of interest. The final value for a tag during a cycle is the most recent value assigned to the tag before the beginning of the cycle. The “final value” of the previous cycle is the same as the “initial value” of the current cycle, except in the case where there is a value at precisely the beginning of the cycle.

The following is an example illustrating time-in-state calculations for a discrete tag. If the following series of values are stored with these timestamps:

| | |
|---|---|
| 23:59 | ON |
| 0:03 | OFF |
| 0:17 | ON |
| 0:23 | OFF |
| 0:31 | ON |
| 0:33 | OFF |
| 0:44 | ON |
| 0:52 | OFF |
| 0:57 | ON |
| 1:02 | OFF |

And then several “time-in-state” calculations are made for the period between 0:00 and 1:00:

| | On | Off |
|---|---|---|
| Total | 0:38 | 0:22 |
| Total Contained | 0:30 | 0:22 |
| Min | 0:03 | 0:02 |
| Min Contained | 0:06 | 0:02 |
| Min Contained Round Trip | 0:13 | 0:10 |

“Non-contained” calculations include occurrences of a state that extend outside a cycle. When calculating a “non-contained” value, the occurrence of the state is assumed to begin/end at the cycle boundary.

Referring to FIG. 3b, the set of calculation types designated via the calculation type option 333 of the time-in-state retrieval operation 330 include a total of ten (10) distinct calculation options for a specified set of state tags.

A “minimum” calculation option returns the (time-wise) shortest duration for each supported state for each tag during each cycle. A “minimum contained” calculation option is similar to the “minimum” calculation, but disregards any state occurrences for a tag that either begin or end outside a cycle.

A “maximum” calculation option returns the (time-wise) longest duration for each supported state for each tag during each cycle. A “maximum contained” calculation option is similar to the “maximum” calculation, but disregards any state occurrences for a tag that either begin or end outside a cycle.

An “average” calculation option returns the (time-wise) average duration for occurrences of each supported state for each tag during each cycle. An “average contained” calculation option is similar to the “average” calculation, but disregards any occurrences of a state that either begin or end outside a cycle.

A “total” calculation option returns the (time-wise) total duration for occurrences of each supported state for each tag during each cycle. A “total contained” calculation option is similar to the “total” calculation, but disregards any occurrences of a state that either begin or end outside a cycle.

A “percent” calculation option returns the percentage of a total cycle time spent in a particular state, for each supported state for each tag during a cycle. A “percentage contained” option is similar to the “percent” calculation, but disregards any occurrences of a state that either begin or end outside a cycle.

The state summary setting 334 specifies a state summary analysis performed over a period including multiple cycles. In an exemplary embodiment, a result is returned regardless of whether the query period begins and ends on cycle boundaries. However, if state summary points are queried for a summary period and the cycle boundaries match the summary period, then all the above calculation types are supported and valid results will be returned by the query engine that executes a requested state summary. On the other hand, if state summary points are queried and the query cycle boundaries do not match the summary periods, then all the above calculations are supported but the results will be returned with a “uncertain” result status (e.g., QualityDetail=64). A state summary occurs over a specified interval (repeated potentially multiple times) that differs from a cycle period for a tag. Take a case where the summary calculation is configured to store summary values each hour at the top of the hour. You can query that data for any interval, for example: a) daily (calculates daily values from the hourly ones), b) hourly (returns the stored values), and c) 15-minute values (approximated from the hourly data—the “average” will be the same for all 4 cycles within the hour, the “integral” will be ¼ of the hourly value, but will be the same for all 4 cycles in the hour, etc.).

In an exemplary embodiment, state summaries calculated for a specified period are provided in the calculated summary values for a cycle where the end of the summary period occurs. Note that this will cause results that will not match queries against the source tag and will cause inaccurate results such as a total state time that is greater than the cycle time.

The following is an example of a state summary calculation specified via the state summary setting 334. A “system time seconds” tag is summarized with a state summary with one minute resolution (summary period). If the system time seconds tag is queried with 10 second intervals, then the following results are observed: in most of the retrieval cycles (5 of 6), no state summary values are reported/recorded, but in a cycle that includes the summary end time (1 of 6—marking the end of the one minute summary period), all 60 states (representing each second within a minute) would be returned with each state having a state time of 1 second for a total of 60 seconds of state time in a 10 second retrieval cycle marking completion of the state summary period (one minute).

Turning to FIG. 3c, a set of settings/options are enumerated for defining a round-trip retrieval mode of the time-in-state retrieval operation 330, The round-trip retrieval mode performs summarization operations on discrete, integer and string tags having a relatively limited number of states—as opposed to analog values that can be assigned any of a relatively large number of (digitized) values. As noted generally above for the time-in-state retrieval operation 330, round-trip retrieval is supported for tags having a limited number of values (“states”). Thus suitable tag types include: integer tags, discrete tags, string tags, state summary tags, and analog tags converted according to grouping criteria (e.g., range designations) to occupy one of a limited number of supported values. The “round-trips” are calculated on a cyclic basis.

The round-trip retrieval mode of the time-in-state retrieval operation 330 retrieves a set of values (corresponding to states) for a tag (or tags) over a given cycle (or multiple) and analyzes the average time period between entry of initial and subsequent occurrences (“round trips”) for particular designated states of the tag. The round-trip retrieval mode is similar to the value state retrieval mode (see, FIG. 3b) in that the round-trip retrieval mode of the time-in-state retrieval operation 330 performs calculations on state occurrences of tags within specified periods containing one or more cycles specified in retrieval queries by a client of a server programmed to support the described functionality of the time-in-state retrieval operation 330. However, in contrast to the value state retrieval mode (which uses the time spent in a certain state as the object of calculations), the round-trip retrieval mode concerns time spans between consecutive leading edges (entry time point) of a same state for a given tag.

A typical application of a round-trip retrieval mode (calculation) is determination/analysis of production cycles for a given production process. Assuming for example that the production process renders one item for each time a given state/value of a tag is recorded, then the time periods between occurrences (round-trips) of the state/value of the tag are analyzed to optimize the production process (e.g., minimize the average time elapsing between consecutive start times of a repeating production sequence). A set of round-trip calculations are supported in an exemplary round-trip retrieval mode of the time-in-state retrieval operation 330 carried out on a programmed server computer system to support a variety of analyses of a production process. Each of the round-trip calculation settings/options are described herein below with reference to FIG. 3c.

Any point on the boundary of the end cycle will be considered to be contained in the next cycle. The point on the boundary of the end query range will not be counted in the calculation except that it will be used to indicate that the previous state is a contained state.

Round-Trip Retrieval Mode Settings

The exemplary round trip retrieval mode supports designating a variety of options to tailor the retrieval of data (including filtering) and specify calculations performed on the resulting data sets to render particular analytical summaries for particular discrete/state tags.

The round-trip retrieval mode includes a time stamp rule option 335 that assigns a timestamp for a given cycle that corresponds to either a start or end time for the cycle.

The round-trip retrieval mode includes a quality rule option 336 that specifies a filter for only using values (points) for a given tag that meet a specified quality level. By default, no quality rule is applied. An example of a quality level is “Good” wherein points assigned a “doubtful” quality status are not considered for state value calculations.

The round-trip retrieval mode includes a calculation type option 337 that specifies the type of summary calculation to be performed during execution of a time-in-state retrieval operation 330 operating in the round-trip mode. In the illustrative example, the following “calculation type” options are supported: Minimum Contained, Maximum Contained, AverageContained, and TotalContained. For each calculation type, summaries are generated for: (1) each supported state of a tag, and (2) each cycle. If a period containing multiple cycles is specified, then the returned calculations are specified separately for each cycle (e.g., if the cycle is one hour and the time period is one day, then 24 separate summaries are rendered). The following is an example of a round trip query where the value of interest is “Total” timespan covered by round trips of any state that is entered multiple times during a cycle (specified by the Resolution parameter) and only contained states are counted.

SELECT TagName, DateTime, Value, StateTime, QualityDetail
FROM History
WHERE TagName IN (‘Welder1’,‘Welder2’)
AND wwRetrievalMode = ‘RoundTrip’
AND wwStateCalc = ‘‘TotalContained’
AND wwResolution = 3600000
AND DateTime >= ‘20100513 00:00:00.000’
AND DateTime <= ‘20100514 00:00:00.000’

In the exemplary embodiment, only contained states are considered, and thus the round-trip calculations omit occurrences of a particular state that either begin or end outside a cycle—and thus are not fully contained inside any calculation cycle. Whether a state is “contained” is determined, for example, by determining a final value for a cycle preceding a cycle of interest. If no round-trip is found within a cycle for a specified tag state, a NULL value is returned. If there is no valid point prior to phantom cycle, a NULL value is returned for the phantom cycle. The phantom cycle is used to get a value for the “leading” or “trailing” end of the overall query. For example, if calculating “hourly” values for 1-day, there will be 24 values—however, if you try to plot those values on a line chart from midnight to midnight, you actually need 25 such values (24 for the day, plus one for midnight the next day, so you know where to draw the line from “11:00 pm” to.

Referring to FIG. 3c, the set of calculation types designated via the calculation type option 337 include a total of four (4) distinct calculation options for a specified state tag(s).

A “minimum contained” calculation option returns the shortest time span between leading edges of each state that occurs at least two times during a cycle. The minimum contained calculation disregards any state occurrences for a tag that either begin or end outside a cycle. As noted above, any state that does not occur at least twice during a cycle is assigned a NULL value for the cycle.

A “maximum contained” calculation option returns the longest time span between consecutive leading edges of each state that occurs at least two times during a cycle. The “maximum contained” calculation disregards any state occurrences for a tag that either begin or end outside a cycle.

An “average contained” calculation option returns the average time span between consecutive leading edges of each state that occurs at least two times during a cycle. The “average contained” calculation disregards any occurrences of a state that either begin or end outside a cycle.

A “total” calculation option returns the total time span between consecutive leading edges of each state that occurs at least two times during a cycle. The “total contained” calculation disregards any occurrences of a state that either begin or end outside a cycle.

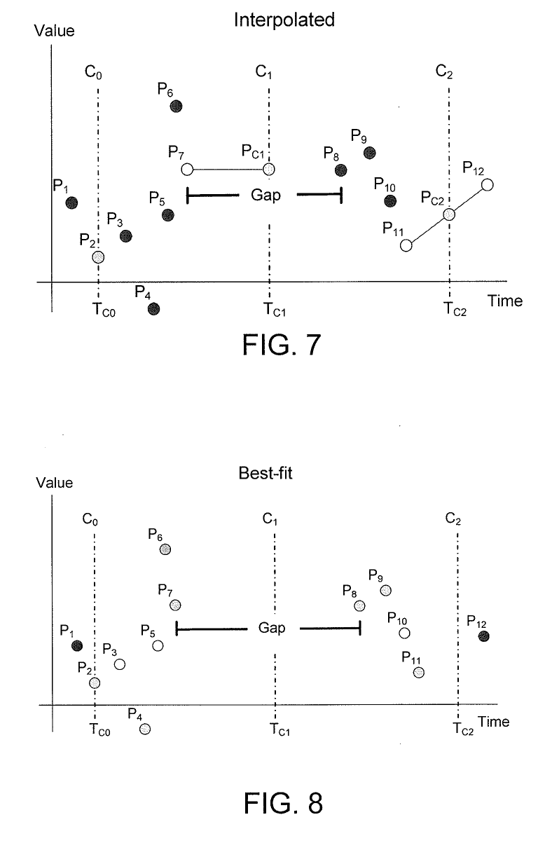

With continued reference to FIG. 3a, the historian 100 also supports an interpolated data retrieval operation 340. The purpose of the interpolated retrieval operation 340 is to use linear interpolation to calculate values to be returned at cycle boundaries. This operation will be described further by way of the illustrated example set forth in FIG. 7. Interpolated retrieval operation 340 operates according to defined cycle boundaries (i.e., operates in a cyclic mode). The interpolated retrieval operation 340 returns one value for each cycle. The time period/span of the interpolated response is determined by the specified number of cycles (in a 24 hour period). In addition to general query options (e.g., tags, time frame, resolution), the interpolated retrieval operation 340 supports an option for overriding the interpolation type and selecting a time stamp rule. The interpolation retrieval operation 340 operates solely on analog tags. For the extent of the query the interpolation type of all other types of tags are forced to stair-step, and results are returned to the client application accordingly.

FIG. 7 shows an example of how points for an analog tag are selected in an interpolated query. In the example an interpolated query specifies a start time of T_{C0} and an end time of T_{C2}. The resolution/cycle duration has been set in such a way that the historian 100 returns data at three cycle boundaries (T_{C0}, T_{C1} and T_{C2}). For the queried tag we find a total of twelve points throughout the cycles represented by the dots marked P₁ through P₁₂. Of these points eleven represent normal analog values, and one, P₇, represents a NULL due to an I/O server disconnect, which causes a gap in the data between P₇ and P₈. Points P₂ and P_{C2} are returned to the requesting client application. The points P₇ , P₁₁ and P₁₂ are used to calculate the returned points at the cycle boundaries. It is noted that since P₂ is at the query start time, no interpolation function is used for that particular cycle boundary. At the next cycle boundary point P_{C1}, is returned—which is the NULL represented by point P₇ shifted forward to time T_{C1}. Finally, at the last cycle boundary point P_{C2} is returned which has been interpolated using points P₁₁ and P₁₂.

The historian 100 supports a Best-fit data retrieval operation 350. The Best-fit retrieval operation 350 uses cyclic buckets, but it is not a true cyclic operation. Apart from an initial value, the Best-fit operation 350 only returns actual delta points. The Best-fit operation 350 invokes low level retrieval to retrieve and provide previously tabled data. The Best-fit retrieval operation 350 applies the best-fit algorithm to the retrieved values in view of the specified resolution. For best-fit and other queries, the user can specify the resolution indirectly by specifying a cycle count. The returned values typically number more than one per cycle. A query option available for the Best-fit data retrieval operation 350 allows overriding the interpolation type for the calculation of initial values. The Best-fit retrieval operation 350 applies a best-fit algorithm to all points found in any given cycle. Thus up to five delta points are returned within each cycle for each tag: the first value, the last value, the min value, the max value and the first occurrence of any existing exceptions. If one point fulfills multiple designations, then the data point is returned only once. In a cycle where a tag has no points, nothing will be returned. The best-fit operation 350 can only be applied to analog tags. For all other tags specified in a client's query, normal delta results are returned by the historian 100 to the client. All points returned to the client will be in chronological order, and if multiple data points are to be returned for a particular time stamp, then those points will be returned in the order in which the client has specified the respective tags in the query.

FIG. 8 shows an illustrative example of selecting points based upon a Best-fit query. In the example the best-fit operation 350, in response to a particular query, commences with a start time of T_{C0} and an end time of T_{C2}. The resolution of the request submitted to the historian is set such that data is returned for two complete cycles starting at T_{C0} and T_{C1} and an incomplete cycle starting at T_{C2}. For the queried tag we again find a total of twelve points throughout the cycles represented by the dots marked P₁ through P₁₂. Of these points eleven represent normal analog values, and one, P₇, represents a NULL due to an I/O server disconnect, which causes a gap in the data between P₇ and P₈. Two points, P₁ and P₁₂, are not considered at all. P₁ is not considered because P₂ is located exactly at the start time and there is no need to interpolate. P₁₂ is not considered because it is outside of the queried time frame. All other points are considered. However, for the reasons provided below, only data points 2, 4, 6, 7, 8, 9 and 11 are returned.

With continued reference to FIG. 8, four points are returned from the first cycle. P₂ is returned as the initial value of the query as well as the first value in the cycle. P₄ is returned as the minimum value in the cycle. P₆ returned as the maximum value and the last value in the cycle. P₇ is returned as the first occurring—and in this case the only—exception in the cycle. In the second cycle three points are returned. P₈ is returned as the first value in the cycle. P₉ is returned as the maximum value in the cycle. P₁₁ is returned as both the minimum value and the last value in the cycle. As no exception occurs in the cycle, no point will be returned for this aspect of the best fit operation 350 for the second cycle. No points are returned for the incomplete third cycle starting at the query end time because the tag (associated with the displayed points) does not have a point exactly at that time.

The historian 100 supports a time-weighted average data retrieval operation 360. The time weighted average (TWA) retrieval operation 360 calculates values, returned at cycle boundaries, using a time weighted average algorithm. The TWA retrieval operation 360 is a true cyclic operation. It returns one value (the average) per cycle for each tag specified in the client's request. In addition to standard query options, the request invoking the TWA retrieval operation 360 allows a client to override the interpolation type and specify timestamp and quality rules. The TWA retrieval operation 360 is applied to analog tags. If a query contains discrete tags, then normal cyclic results are returned for those tags.

FIG. 9 illustratively depicts a sequence of data points for a specified tag to aid understanding the calculated results rendered by the TWA retrieval operation 360. In the example a TWA query has a start time of T_{C0} and an end time of T_{C2}. The resolution has been set such that the TWA retrieval operation 360 returns data for two complete cycles starting at T_{CO} and T_{C1} and an incomplete cycle starting at T_{C2}.

A total of nine points (marked P₁ through P₉) are provided for the queried tag throughout the shown cycles. Of these points eight represent normal analog values, and one, P₅, represents a NULL due to an I/O server disconnect, which causes a gap in the data between data points P₅ and P₆.

Assuming the query calls for time stamping at the end of the cycle, the ‘initial value’ to be returned at the query start time, in this example T_{C0}, is not a simple stair-step or interpolated value as is usual. Instead the initial value is the result of applying the TWA algorithm to a cycle immediately preceding the query range. In the same scenario the value returned at time T_{C1} is the result of applying the TWA algorithm to points in the cycle starting at the query start time, and the value to be returned at the query end time T_{C2} is the result of applying the TWA algorithm to the points in the cycle starting at T_{C1}.

Taking the last cycle depicted in FIG. 9 as an example, in order to calculate a time weighted average, the area under the curve (depicted by the lines connecting contained non-null points P₆, P₇, P₈ and P₁₂ which represents the interpolated value at time T_{C2} using points P₈ and P₉) is initially determined. The data gap at the beginning of the cycle, caused by the I/O server disconnect, does not contribute to the calculated area. Furthermore, if a quality rule of “only good” points is specified, then points with doubtful quality will not contribute to the area calculation. Focusing upon points P₆ and P₇, the TWA operation 360 calculates the area contribution between these two points by multiplying the arithmetic average of value P₆ and value P₇ by the time difference between the two points—that is ((P₆+P₇)/2)×(T₇−T₆). After calculating the area for the whole cycle, the TWA calculation is finished by dividing the area under the curve by the cycle time (less any periods within the cycle, which did not contribute anything to the area calculation). This calculated average is returned at the cycle end time.

Referring to the first cycle depicted in FIG. 9, it is noted that in the time frame between points P₄ and P₅, the line through point P₄ representing the area under the curve is parallel to the X-axis (i.e., the value is constant). This is due to the fact that P₅ represents a NULL point value, which cannot be used to calculate an arithmetic average. Instead the historian 100 uses the value P₄ for the whole time period between points P₄ and P₅. The area calculation is signed. Therefore, if the arithmetic average between two points is negative, then the contribution to the area is negative.

The historian 100 supports a min-with-time data retrieval operation 370. The min-with-time data retrieval operation 370 operates upon cyclic buckets. However, the min-with-time operation 370 is not a true cyclic mode. With the exception of an initial value, the points retrieved are delta points (i.e., where a tag value has changed). The values/rows returned by low level retrieval components of the historian 100 potentially number more than one per cycle. A new column is supported that identifies the number of delta points for a tag that are returned for the cycle. The min-with-time data retrieval operation 370 supports a requestor overriding the default/specified interpolation type for calculating initial values.

The min-with-time retrieval operation 370 applies a simple minimum algorithm to all points retrieved by low level retrieval in any given cycle, and returns a data point having a minimum value along with its actual timestamp. In a cycle where a tag has no points nothing will be returned. The minimum-with-time algorithm can only be applied to analog tags. For all other tags normal delta results are returned to the requesting client of the historian 100. All points returned to the client are in chronological order. If multiple points (for different tags) are returned for a particular time stamp, then those points will be returned in the order in which the client has specified the respective tags in the query.

FIG. 10 shows an example of how the minimum algorithm selects points for an analog tag. The min-with-time operation 370 is executed with a start time of T_{C0} and an end time of T_{C2}. The time period has been set such that data is returned for two complete cycles starting at T_{C0} and T_{C1} and an incomplete cycle starting at T_{C2}. A total of twelve points are identified for the queried tag throughout the cycles represented by the dots marked P₁ through P₁₂. Of these points eleven represent normal analog values, and one, P₇, represents a NULL due to an I/O server disconnect, which causes a gap in the data between P₇ and P₈. Two points, P₁ and P₁₂, are not considered at all. P₁ is not considered because we do not need to interpolate at the query start time, since P₂ is located exactly at the start time. P₁₂ is not considered because it is outside of the queried time frame. All other points are considered, but only points P₂ P₄ P₇ and P₁₁ are returned. P₂ is returned as the initial value of the query. P₄ is returned as the minimum value in the first cycle. P₇ is returned as the first and only exception occurring in the first cycle. P₁₁ is returned as the minimum value in the second cycle. No points are returned for the incomplete third cycle starting at the query end time, because the tag does not have a point exactly at that time.

The last of the illustrative extensible set of advanced retrieval operations supported by the historian 100 is a maximum-with-time data retrieval operation 380. The maximum-with-time retrieval operation 380 uses cyclic buckets, but it is not a true cyclic operation. Apart from the initial value all subsequently returned data points are delta points. The rows returned by low level retrieval may number more than one per cycle. A call to the maximum-with-time data retrieval operation 380 optionally overrides a specified interpolation type for the calculation of initial values.

The maximum-with-time retrieval operation 380 applies a very simple maximum algorithm to time stamped data points for a tag found in any given cycle and returns a point having a maximum value with its actual timestamp. In a cycle where a tag has no data points, nothing will be returned. The MAX-with-time algorithm is applied to analog tags. For all other tags normal delta results are returned to the client. All points returned by the historian 100 to a requesting client are in chronological order. If multiple points (from different tags) are returned for a particular time stamp, then the points are returned in the order in which the client has specified the respective tags in the query that invoked the maximum-with-time operation 380.

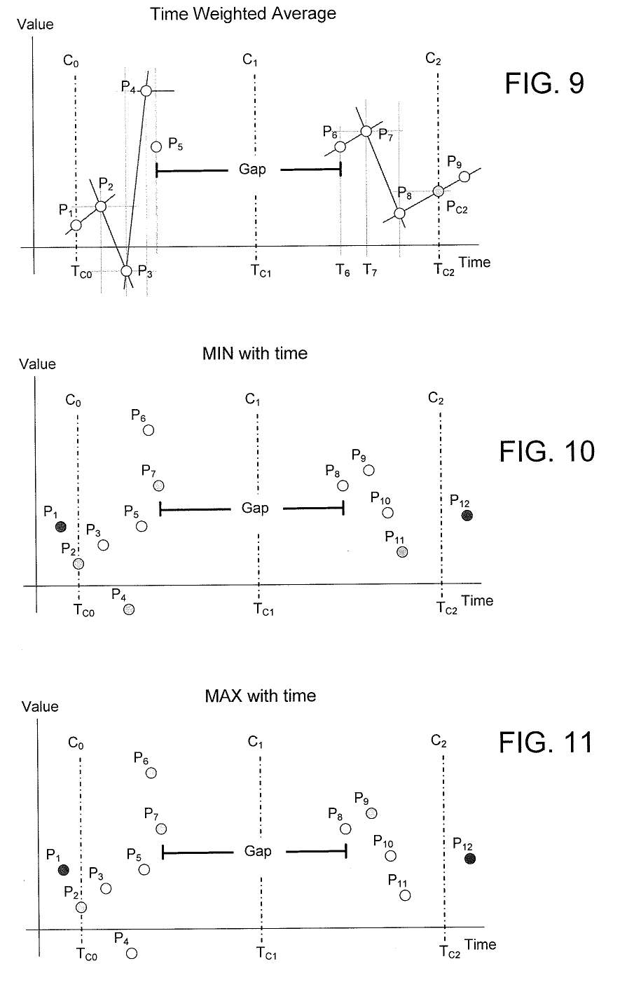

FIG. 11 shows an example of how the maximum-with-time algorithm selects data points for an analog tag. In the example the maximum-with-time operation 380 executes with a start time of T_{C0} and an end time of T_{C2}. The time period has been set such that data is returned for two complete cycles starting at T_{C0} and T_{C1} and an incomplete cycle starting at T_{C2}. A total of 12 data points are identified for the specified tag during the designated time frame. The points are labeled P₁ through P₁₂. Of these points eleven represent normal analog values, and one, P₇, represents a NULL due to an I/O server disconnect, which causes a gap in the data between data points P₇ and P₈. Two points, P₁ and P₁₂, are not considered. P₁ is not considered because there is no need to interpolate at the query start time because P₂ is located exactly at the start time, and P₁₂ is not considered because it is outside of the queried time frame. All other points are considered, but only points P₂ P₆ P₇ and P₉ are returned. P₂ is returned as the initial value of the query. P₆ is returned as the maximum value within the first cycle. P₇ is returned as the first and only exception occurring in the first cycle, and P₉ is returned as the maximum value in the second cycle. No points are returned for the incomplete third cycle starting at the query end time because the tag does not have a point exactly at that time.

It is noted that the historian 100 embodies an extensible platform facilitating defining/incorporating any further developed advanced retrieval operations. The ability to handle a virtually limitless number of the advance retrieval operations is largely attributable to the production of the values in response to client queries as opposed to when the streaming input data is received and stored by the historian 100.

Having described an exemplary functional/structural arrangement for a historian incorporating advanced data retrieval operations, attention is directed to a flow diagram summarizing the general operation of the historian 100, schematically depicted in FIG. 2 and including the advanced data retrieval operations 204, to process requests from clients invoking specified ones of the advanced data retrieval operations 204 to render secondary/advanced data. The invoked operations render the secondary/advanced data by applying defined data processing algorithms on data retrieved from the tables 202.

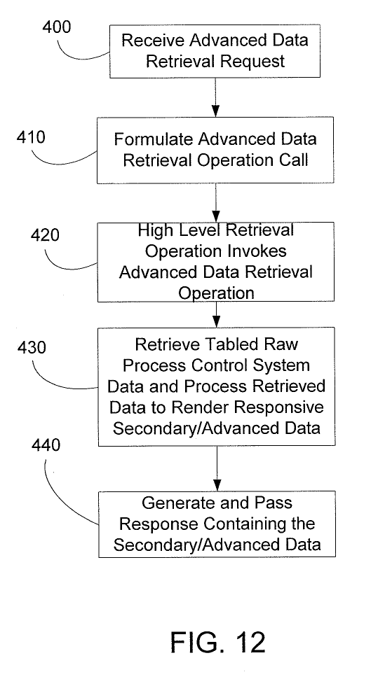

Turning to FIG. 12, during step 400, the historian 100 receives a request from the client application on node 112a via the data retrieval interface 206. The request generally identifies one or more data items (e.g., tags) and one of the advanced data retrieval operations. Thereafter, at step 410 an appropriate interface call (e.g., SQL Query) is formulated from the received request. During step 410 the options specified in the request and a set of option defaults are used to tailor a set of parameters passed in the interface call that will be used to invoke an advanced data retrieval operation corresponding to the received request. At step 420 the interface call is issued thereby invoking the advanced data retrieval operation corresponding to the received request. Next, at step 430, the invoked advanced data retrieval operation retrieves previously tabled data maintained in the data tables 202 and processes the retrieved tabled data to render responsive advanced data corresponding to the advance data retrieval request received during step 400. At step 440 the historian 100 generates a response to the received advanced data retrieval request and passes the response to the client application on node 112a.

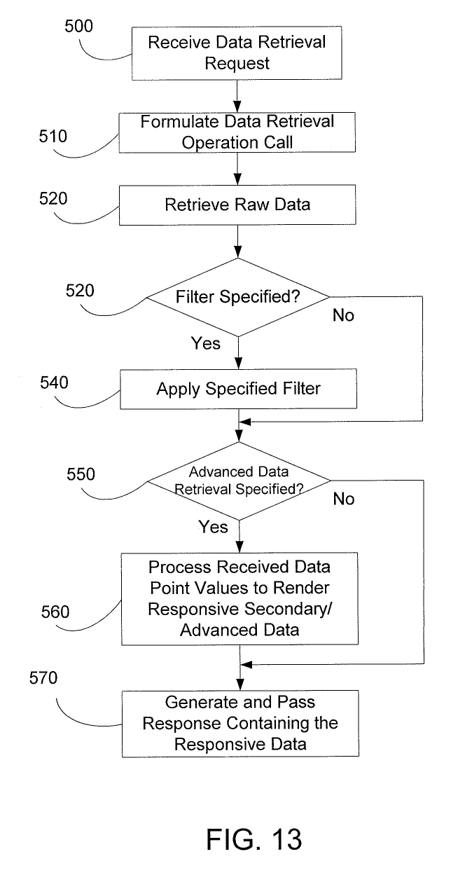

Having described an exemplary set of advanced retrieval operations executed by a programmed computer system in accordance with computer instructions read from a physical computer readable medium, attention is directed to a further enhancement to the above-described system wherein the retrieval filters 203 optionally pre-process raw VTQ data streams to render a modified (filtered) VTQ stream. The modified VTQ steam is thereafter: (1) further processed by performing one of the described advanced data retrieval operations (204), and/or (2) forwarded via the data retrieval interface 206 to a client application (e.g., a historic data display monitor that displays a data stream, or streams, for a designated time period). In systems that do not provide such filtering before carrying out advanced retrieval operations (204), erroneous results are potentially provided. For example, a transient spike in a particular value could lead to an inaccurate portrayal of a process' range of operation for a particular parameter (e.g., pressure, temperature, flow, etc.). An exemplary set of steps carried out under programmed control of a server (see, FIG. 2, server 100) are summarized in FIG. 13, and an exemplary set of retrieval filters (see, FIG. 2, retrieval filters 203) is described herein below with reference to FIG. 14.

Turning to FIG. 13, an exemplary flow diagram is provided showing the data flow/processing stages for an exemplary retrieval process carried out by a system of the type represented in FIG. 2 including the historian 100. The flow diagram of FIG. 13 includes conditional branches to particular functions for carrying out optional processing on retrieved raw data streams by the retrieval filters 203 (see, FIG. 14, exemplary retrieval filters) and the advanced data retrieval operations 204. During step 500, the historian 100 receives a request from the client application on node 11a via the data retrieval interface 206. The request identifies one or more data items (e.g., tags) and a time span of interest. Moreover, the request (query) optionally specifies for each of the listed tags: (1) retrieval filters to be applied to the responsive raw data stream; and/or (2) one or more advanced data retrieval operations. In an exemplary embodiment, advanced retrieval operations (see, FIG. 3a) support options for tailoring data retrieval and processing tasks performed by the advanced retrieval operation. Options specified in a request invoking a particular advanced retrieval operation include, for example, an interpolation method, a timestamp rule, and a data quality rule. Each of these three retrieval options is described herein above in association with FIG. 3a.

Thereafter, at step 510 an appropriate interface call (e.g., SQL Query) is formulated from the received request to retrieve a set of raw VTQ data for a specified tag (or tags) and a time span. At step 520 raw VTQ data is received from the data tables 202. Control then passes to step 530.

During step 530 the data retrieval request is analyzed to determine whether the request includes parameters specifying one or more filtering processes are to be performed on the raw VTQ data received during step 520. In particular, if at step 530 a filter of the retrieval filters 203 is specified in the data retrieval request from a client, then control passes to step 540.

During step 540 one or more specified filters of the retrieval filters 203 (see, e.g., analog filters identified in FIG. 14 described herein below) are applied to the raw VTQ data received during step 520 to render a filtered VTQ data stream for a tag (or tags). In the exemplary embodiment the filters operate on analog data. The exemplary set of analog filters perform: removal of statistical outliers, analog-to-discrete (Boolean) conversion, and snap-to-base value transformation. However, in alternative embodiments both discrete and analog filters are available to operate on VTQ data acquired from the data tables 202 during step 520.

If no filters are specified then control passes from step 530 to step 550 without filtering the raw VTQ data.

At step 550 the client request parameters are again analyzed to determine whether to apply an advance data retrieval mode (see, FIG. 3a) on raw/filtered data provided as a result of performing step 520 and (potentially) step 540. If, at step 550 an advanced data retrieval mode is specified, then control passes to step 560 wherein advanced data retrieval post-processing is performed on the retrieved raw/filtered VTQ data steam for the specified time span. During step 560 post-processing is performed using an advanced data retrieval operation specified, by way example, from the set of advanced data retrieval operations identified in FIG. 3a to render responsive advanced retrieval mode data sets for display on a requesting client's monitor. The post-processing is performed in accordance with a set of options including: an interpolation type, a quality rule, and a timestamp rule (described herein above with reference to FIG. 3a).

Control then passes to step 570 wherein the historian 100 generates a response to the received data retrieval request based upon the execution of steps described herein above and passes the response to the client application on node 112a.

Turning to FIG. 14, in an exemplary embodiment, described herein below, a set of three (analog) retrieval filters are provided: statistical 600 (removes outlier), simple analog to discrete (Boolean) 610, and snap-to-base value transformation 620. The three retrieval identified analog filters are exemplary and other retrieval filters are contemplated in alternative embodiments.

The statistical filter 600 removes data point instances (outliers) having a value deviating from a mean value by a specified amount in a set of raw analog data points retrieved from the data tables 102 for a specified tag/time period. An example of filtering outliers from a set of points is illustratively presented in FIG. 15. Most data point values in a set of raw data for a specified period shown in FIG. 15 fall within a relatively close value space. However two data point instances—identified as “outliers”—fall substantially outside a range of retrieved point value instances falling within an oval. The statistical filter 600 removes the two outlier data points from the raw retrieved VTQ data set during the filtering step 530 described previously herein.

In a particular illustrative embodiment, the statistical filter 600 is used to pre-process a raw set of data points for subsequent processing by, for example, an analog advanced data retrieval mode (see, FIG. 3a). The statistical filter 600's range is configured by specifying a value “n” for a retrieval mode that initially calculates: (1) a time weighted mean (mu), and a time weighted standard deviation (sigma). In such case, points falling outside a configured range defined by “mu−(n)(sigma)” and “mu+(n)(sigma)” are classified as statistical “outliers” and therefore discarded from the raw set of data points when rendering a filtered data point set. In the exemplary embodiment, a user adjusts the range of acceptable deviation from the time weighted mean (mu) by changing the value of “n” during specification of the statistical filtering aspect of the retrieval operation. Also, in an exemplary embodiment, if a first point value in a raw input data point set is filtered out by the statistical filter 600, then the removed/filtered value is replaced by a point having a value equal to the time weighted mean for the set of raw retrieved data points.

In the illustrative embodiment the time weighted standard deviation (sigma) is calculated as:

$$sigma = Sqrt ( integralOfSquares - 2 * timeWeightedAverage * integral + totalTime * timeWeightedAverage * timeWeightedAverage ) / totalTime )$$

The IntegralOfSquares value is determined by multiplying the square of the tag by the time duration of the value of the tag. The integral is the tag value times the duration of the value of the tag.

The above equation is the single pass equivalent to the formula for weighted standard deviation:

$${σ}_{weighted}^{2} = {\sum }_{i = 1}^{N} {{w}_{i} ( {x}_{i} - {μ}^{*} )}^{2}$$

In the above well-known equation mu* is the time-weighted mean (average) for the tag of interest. Therefore, a time-weighted sum is calculated of the square of the difference between a set of point values and the time-weighted mean of the points.

The following is an exemplary cyclic query example using the statistical filter 600 without specifying the n value (resulting in the use of the default value of 2 for n):

SELECT DateTime, Value, wwFilter

FROM History

WHERE TagName = (‘TankLevel’)

AND DateTime >= ‘2008-01-15 15:00:00’
AND DateTime <= ‘2008-01-15 17:00:00’
AND wwRetrievalMode = ‘Average’
AND wwFilter = ‘SigmaLimit( )’

The result set might look like this:

| DateTime | Value | Filter |
|---|---|---|
| 2008-01-15 15:00:00.000 | 34.56 | SigmaLimit( ) |
| 2008-01-15 16:00:00.000 | 78.90 | SigmaLimit( ) |
| 2008-01-15 17:00:00.000 | 12.34 | SigmaLimit( ) |

The analog-to-discrete filter 610 converts a set of raw analog data point values into a set of discrete data point values (e.g., 0/1, True/False, On/Off, etc.) according to a single specified range. In the case of the analog-to-discrete filter 610, a single value is specified that marks the border between a zero (0) and a one (1) value assigned to converted data points within the set of raw data points processed by the analog-to-discrete filter 610. In an exemplary embodiment, the analog-to-discrete filter 610 is configured by specifying an analog “cutoff” value and an operator (>, >=, <, or <=). In the exemplary embodiment, NULL values are copied unchanged to the filtered data point set.

The following is an exemplary query invoking the “ToDiscrete” analog-to-discrete filter 610.

SELECT DateTime, vValue, StateTime, wwFilter

FROM History

WHERE TagName IN (‘SysTimeSec’)

AND DateTime >= ‘2008-01-15 15:00:00’
AND DateTime <= ‘2008-01-15 17:00:00’
AND wwRetrievalMode = ‘ValueState’
AND wwStateCalc = ‘MinContained’
AND wwResolution = 7200000
AND wwFilter = ‘ToDiscrete(29, >)’

Here the ToDiscrete filter's operator is specified as “>”, so values greater than but not including 29 are internally converted to ON (1), whereas values from 0 to 29 are converted to OFF (0).

The query could return the following rows:

| DateTime | Value | StateTime | Filter |
|---|---|---|---|
| 2008-01-15 15:00:00.000 | 0 | 30000 | ToDiscrete(29, >) |
| 2008-01-15 15:00:00.000 | 1 | 30000 | ToDiscrete(29, >) |
| 2008-01-15 17:00:00.000 | 0 | 30000 | ToDiscrete(29, >) |
| 2008-01-15 17:00:00.000 | 1 | 30000 | ToDiscrete(29, >) |

The values returned in the StateTime column tell us, that the shortest amount of time, that SysTimeSec assumed values having a filtered equivalent to either ON or OFF and remained in that state (either the ON or the OFF state) was 30 seconds.

A similar RoundTrip advanced retrieval query utilizing the “ToDiscrete” filter would look like this:

SELECT DateTime, vValue, StateTime, wwFilter

FROM History

WHERE TagName IN (‘SysTimeSec’)

AND DateTime >= ‘2008-01-15 15:00:00’
AND DateTime <= ‘2008-01-15 17:00:00’
AND wwRetrievalMode = ‘‘RoundTrip’
AND wwStateCalc = ‘MaxContained’
AND wwResolution = 7200000
AND wwFilter = ‘ToDiscrete(29, <=)’

Here the operator is specified as “<=”, so the resulting conversion is exactly opposite to that performed in the previous query. Now values smaller than or equal to 29 are internally converted to ON, whereas values from 30 to 59 are converted to OFF.

The query could return the following rows:

| DateTime | vValue | StateTime | Filter |
|---|---|---|---|
| 2008-01-15 15:00:00.000 | 0 | 60000 | ToDiscrete(29, <=) |
| 2008-01-15 15:00:00.000 | 1 | 60000 | ToDiscrete(29, <=) |
| 2008-01-15 17:00:00.000 | 0 | 60000 | ToDiscrete(29, <=) |
| 2008-01-15 17:00:00.000 | 1 | 60000 | ToDiscrete(29, <=) |

The values returned in the StateTime column now tell us, that the longest amount of time found between roundtrips for both the OFF and the ON state within the 2-hour cycle was 60 seconds.

The snap-to-base value filter 620 modifies a set of raw analog data point values according to one or more specified base values and a specified tolerance around each specified base value. The snap-to-base value filter 620 enables forcing values in specified ranges (tolerances) around base values to “snap to” the specified base value. The snap-to-base filter 620 is usable with all retrieval modes. However, the snap-to-base value filter 620 is especially beneficial in aggregate retrieval modes (see, FIG. 3a above) including: Average, Integral, Minimum and Maximum advanced retrieval modes.

In a particular application, a tank is known to be empty, but a process variable data tag that stores the tank level returns a noisy value close to zero (instead of exactly zero). A user can invoke snap-to-base value filter 620 to force the value to register as exactly zero when the tank is empty. The snap-to-base value filter 620 requires specification of two configuration parameter values: tolerance (e.g., 0.01, a default value if no tolerance is supplied with the query); and base value(s) around which the snap-to value conversions will occur during operation of the snap-to-base filter 620. An exemplary syntax for specifying a snap-to filter is:

SnapTo([tolerance[,base_value_{—}1[, base_value_{—}2] . . . ]])

When the snap-to-base value filter 620 is applied to a set of raw data point values for a tag, point values falling inside any of the ranges [Base value−Tolerance, Base value+Tolerance] will be forced to the base value for the range, before the point goes into further retrieval processing using the advance retrieval modes identified in FIG. 3a.

If multiple base values are specified, and the resulting ranges overlap, the first matching base value is used.

A query example from the History table using the Snapto filter 620 looks like this:

SELECT DateTime, Value, wwFilter

FROM History

WHERE TagName = (‘TankLevel’)

AND DateTime >= ‘2008-01-15 15:00:00’
AND DateTime <= ‘2008-01-15 17:00:00’
AND wwRetrievalMode = ‘Average’
AND wwResolution = 3600000
AND wwFilter = ‘SnapTo(0.01, 0, 1000)’

The following rows might be returned:

| DateTime | Value | Filter |
|---|---|---|
| 2008-01-15 15:00:00.000 | 0 | SnapTo(0.01, 0, 1000) |
| 2008-01-15 16:00:00.000 | 875.66 | SnapTo(0.01, 0, 1000) |
| 2008-01-15 17:00:00.000 | 502.3 | SnapTo(0.01, 0, 1000) |

The quality detail for values modified with this filter will have a QualityDetail bit flag 0x2000 (value changed by filter) set.

In view of the many possible embodiments to which the principles of this invention may be applied, it should be recognized that the embodiments described herein with respect to the drawing figures, as well as the described alternatives, are meant to be illustrative only and should not be taken as limiting the scope of the invention. The functional components disclosed herein can be incorporated into a variety of programmed computer systems in the form of software, firmware, and/or hardware comprising computer executable instructions on a storage medium. Furthermore, the illustrative steps may be modified, supplemented and/or reordered without deviating from the invention. Therefore, the invention as described herein contemplates all such embodiments as may come within the scope of the following claims and equivalents thereof.

What is claimed is:

1. A control system database server incorporating a database service in the form of a computer-readable medium storing computer-executable instructions supporting advanced data retrieval operations for creating, on-request by database service clients, sets of processed data from previously tabled control system data stored from streams of real-time data points, the control system database server comprising:
a general data retrieval interface through which the database server receives database queries from clients;
a set of advanced data retrieval operations, interposed between the general data retrieval interface and low level data retrieval components of the server, that, when invoked by an advanced data retrieval request from a client, retrieves data from previously tabled control system data, and processes the retrieved tabled data to render responsive data corresponding to the advanced data retrieval request; and
a filter stage that, when invoked, receives data from previously tabled control system data, and processes the received tabled data to render a filtered data set that is, in turn, provided to the set of advanced data retrieval operations for further processing.

2. The control system database server of claim 1 wherein the filter stage includes computer-executable instructions for converting a set of analog data values to a set of discrete values.

3. The control system database server of claim 2 wherein the set of potential discrete values consist of: two Boolean states and a NULL state.

4. The control system database server of claim 2 wherein the set of potential discrete values correspond to a set of defined contiguous, non-overlapping ranges.

5. The control system database server of claim 1 wherein the filter stage includes computer-executable instructions for removing statistical outlying data point instances based upon statistical deviation from a calculated target.

6. The control system database server of claim 5 wherein the calculated target is a time-weighted mean.

7. The control system database server of claim 1 wherein the filter stage includes computer-executable instructions for modifying data point values within a specified tolerance range of a base data point value such that data point instances falling within the range are assigned the base value.

8. The control system database server of claim 1 wherein the set of advanced data retrieval operations includes a time-in-state data retrieval operation that returns a set of calculated time-in-state statistics for a data stream during a time span.

9. The control system database server of claim 8 wherein the time-in-state data retrieval operation includes a round trip calculation mode for analyzing reoccurrences of a particular state within cycles.

10. The control system database server of claim 8 wherein the time-in-state data retrieval operation includes a contained state calculation mode for limiting cyclical analysis to fully contained states within each cycle as evidenced by a transition to the state and a transition from the state within the cycle.

11. A method, performed by a control system database server incorporating a database service in the form of a computer-readable medium storing computer-executable instructions supporting a set of advanced data retrieval operations, for creating, on-request by database service clients, sets of processed data from previously tabled control system data corresponding to previously received real-time data streams, the method comprising the steps of:
receiving a data retrieval request specifying one of the advanced data retrieval operations;
invoking, on the database server, an advanced data retrieval operation, interposed between a data retrieval request interface and low level data retrieval components of the server, corresponding to the advanced data retrieval operation specified in the received data retrieval request, and in response performing, in accordance with the invoked advanced data retrieval operation the further steps of:
retrieving data from the previously tabled control system data, and
processing the retrieved data to render responsive advanced data corresponding to the advanced data retrieval request; and
receiving, by a filter stage, data from previously tabled control system data, and processing the received tabled data to render a filtered data set that is, in turn, provided to the set of advanced data retrieval operations for further processing according to the invoking step.

12. The method of claim 11 wherein the processing by the filter stage includes converting a set of analog data values to a set of discrete values.

13. The method of claim 12 wherein the set of potential discrete values consist of: two Boolean states and a NULL state.

14. The method of claim 12 wherein the set of potential discrete values correspond to a set of defined contiguous, non-overlapping ranges.

15. The method of claim 11 wherein the processing by the filter stage includes removing statistical outlying data point instances based upon statistical deviation from a calculated target.

16. The method of claim 11 wherein the processing by the filter stage includes modifying data point values within a specified tolerance range of a base data point value such that data point instances falling within the range are assigned the base value.

17. The method of claim 11 wherein the set of advanced data retrieval operations includes a time-in-state data retrieval operation that provides, as a result of the processing the retrieved data step, a set of calculated time-in-state statistics for a data stream during a time span.

18. The method of claim 17 wherein the time-in-state data retrieval operation includes a round trip calculation mode for analyzing reoccurrences of a particular state within cycles.

19. The method of claim 17 wherein the time-in-state data retrieval operation includes a contained state calculation mode for limiting cyclical analysis to fully contained states within each cycle as evidenced by a transition to the state and a transition from the state within the cycle.

20. A computer-readable medium including computer-executable instructions, performed by a control system database server incorporating a database service in the form of a computer-readable medium storing computer-executable instructions supporting a set of advanced data retrieval operations, for facilitating creating, on-request by database service clients, sets of processed data from previously tabled control system data corresponding to previously received real-time data streams, the computer-executable instructions facilitating performing the steps of:
receiving a data retrieval request specifying one of the advanced data retrieval operations;
invoking, on the database server, an advanced data retrieval operation, interposed between a data retrieval request interface and low level data retrieval components of the server, corresponding to the advanced data retrieval operation specified in the received data retrieval request, and in response performing, in accordance with the invoked advanced data retrieval operation the further steps of:
retrieving data from the previously tabled control system data, and
processing the retrieved data to render responsive advanced data corresponding to the advanced data retrieval request; and
receiving, by a filter stage, data from previously tabled control system data, and processing the received tabled data to render a filtered data set that is, in turn, provided to the set of advanced data retrieval operations for further processing according to the invoking step.
